(19) United States
(12) Patent Application Publication
(10) Pub. No.: US 2016/0191470 A1
(43) Pub. Date: Jun. 30, 2016

(54) Method and apparatus for securely transmitting communication between multiple users

(71) Applicant: Ajay Movalia, Parsippany, NJ (US)

(72) Inventor: Ajay Movalia, Parsippany, NJ (US)

(21) Appl. No.: 14/821,525

(22) Filed: Aug. 7, 2015

Related U.S. Application Data
(60) Provisional application No. 62/034,154, filed on Aug. 7, 2014.
(60) Provisional application No. 62/097,134, filed on Dec. 29, 2014.

(51) Int. Cl. H04L 29/06; H04L 9/14

(52) U.S. Cl. CPC H04L 63/0428; H04L 63/061; H04L 9/14; H04L 2209/24

(57) ABSTRACT

A computer driven apparatus comprising at least one client device, where this client device is capable of managing and storing data. The apparatus further comprises a central location for managing subscriptions, addresses and public encryption keys. The central location does not store or come in contact with any of the client communication but serves to provide logistical support for connected clients. The apparatus uses symmetric and asymmetric encryption to encrypt messages and symmetric and asymmetric decryption decrypt messages by the receiver. Only one portion of the encryption mechanism is stored by a third party. The apparatus uses a discovery mechanism to determine the appropriate encryption key for each recipient, or to identify whether encryption is supported by the intended recipient. The apparatus further comprises support for sorting messages by sender and other extended options, as well as extended forwarding choices with respect to attachments and plurality of recipients.

### CLAIM OF PRIORITY

This application claims prior of a U.S. Provisional Application No. 62/034,154, filed on Aug. 8^{th}, 2014, and of a U.S. Provisional Application No. 62/097,134, filed on Dec. 29^{th}, 2014, the contents of which are fully incorporated herein by reference.

### FIELD OF THE INVENTION

The invention relates to a computer application, in particular, to an application used to securely transmit messages and other data between electronic devices. The invention also relates to a decentralized secure internet mail system, where messages are being managed by clients. The invention also relates to a system and method for sorting and redirecting a plurality of messages and their attachments.

### BACKGROUND OF THE INVENTION

Like precious metals, personal written communication has long been recognized as a valuable asset. The originators of personal communication, as well as the intended recipients, expended enormous time and energy trying to safeguard the privacy of their communication. Even the most benign sample of personal correspondence often contained confidential information, which could be used to betray, embarrass or manipulate either party if obtained by the wrong people. Communication considered especially secret and sensitive was not entrusted to a postman, but was instead sent with a messenger, who was a specially hired confidant to hand deliver the message to the intended recipient.

The advent of electronically delivered communication did not change the way we think about personal communication. People still consider their private email and SMS messages as confidential and are apt to use such communication to reveal secrets or express their private thoughts. At the same time, electronic communication with its interconnected computers significantly undermines the old assurances and safeguards to privacy offered by the iconic postman. Furthermore, systems and networks carrying messages are predominantly privately owned and operated. Different concerns apply different meaning and a varying degree of importance to the terms confidentiality, privacy, safety and security. Adherence of these tenets also varies by proprietor. Therefore, at any point in the journey of a message, or for that matter any other piece of data, it may be intercepted by a snooper.

Electronic mail has ushered an era of unprecedented level of simple, affordable interpersonal electronic communication and delivery of news and information. It has also vastly expanded the pool of parties interested in capturing this private but vulnerable information. Interested parties include government intelligence agencies, data gathering shops for marketing and trending, and illegitimate consumers, such as hackers and phishers.

Protection of electronically transmitted data is essential and various methodologies have been implemented and are widespread. Many safeguards exist to secure transmittal of data and ensure that it reaches the intended recipients. However, all of the present solutions suffer from various shortcomings that the present invention aims to correct.

The first limitation common to most existing solutions present in the prior art is the central location of data. This creates a central point of vulnerability, and hackers or spies focus their attacks or requests for data on this identifiable central source. The second drawback, is that participants lose control of their data. They can no longer dictate who, where and when can have access to their messages. History is replete with incidents were data was accessed under the color of the law or through dishonest means. The present invention overcomes these shortcomings because data is not stored centrally and the data in transit is subject to the multi-layer encryption embodied by the present invention.

The present invention extends the benefits of encryption to other critical areas of data interaction between individuals and businesses. The first is social media. Presently, messages from social sites are sent without any encryption. Furthermore, data belonging to the account holders of those utilizing social media for interaction is stored on central servers in an unencrypted state. A determined attacker is thus able to hack through the outer defenses of such a system, or place a listener or a spoofer to intercept messages in transit. The present invention, which calls for data encryption during storage and transmission, will render efforts of even the most determined hacking attack useless.

Various implements are known in the art, but fail to address all of the problems solved by the invention described herein. One embodiment of this invention is illustrated in the accompanying drawings and will be described in more detail herein below.

### SUMMARY OF THE INVENTION

The invention relates to sending messages from one user to another over a network of globally connected servers commonly known as the internet. This communication is done securely and in a way that virtually eliminates the possibility of messages being intercepted and opened by hackers. Government bodies seeking access will not be prevented from lawful access. However, the present invention will ensure that access is indeed lawful and that no more than what is required for disclosure is being released.

The invention also relates to an efficient mechanism of dispatching messages to multiple parties by providing an option to reply to one or to reply to all senders with or without attachments. Even for large scale messaging the software application embodied in this invention is preserved. Thus a sender has a choice to send or forward messages, as well as to send or forward these messages with or without an attachment.

The invention also relates to secure storage of public and private keys. The public keys are stored centrally since they are useless without private keys. Private keys are stored by clients, but these keys are useless without a decrypting password. A decrypting password is preferably stored securely by a third party password storage facility.

Additionally, the invention relates to fast public key discovery mechanism. The system is able to determine whether the sender or receiver of a message is a subscriber to the software embodied by this invention. Appropriate keys are discovered by the software on the central server and presented to the requesting client for the encryption step. Non-discovery of such keys causes messages to be issued to these clients in a non-secure fashion. No additional input is required for either receiver or the sender of this communication.

An additional benefit of this invention relates to the dual mode of message dispatching and designation. Message dispatching relates to how a message is sent and received and designation refers to how the message appears to the client. The software embodied by this invention alerts a subscribing user whether the recipient or the intended target is a subscriber to the software. Non-subscribers cannot utilize the encryption mechanism of this invention and need to be able to send and receive unencrypted messages. Both encrypted and unencrypted messages are stored in the same bin, but each is clearly marked so that sensitive information is not accidentally sent to unsubscribing party.

Yet another benefit of the present invention is the ability to encrypt any kind of data the same way a mail message is encrypted and sent. Encryption is not limited by the type of data it encrypts. Furthermore the application embodied by the present invention still utilizes convention data transfer protocols and mechanisms once the file or a data segment has been encrypted.

The present invention also relates to stealth mode enablement on triggered events. The subscriber of the software is normally able to view the messages arriving at the incoming bin, without having to enter and re-enter the password for each message. This is true because the software embodied in the present invention stores the required keys and password automatically. To an authorized user, each message appears as plain text without the requirement of additional input. However, the software application can decouple password from the stored keys and password with a single, clearly marked option that can be tapped or clicked. Similar decoupling can occur if the software detects unauthorized access, such as multiple login attempts or in response to on an alarm from a firewall or antivirus application.

Yet another benefit of the present invention is to make social media interaction more secure and hacking proof without adding a lot of data processing overhead and without overburdening existing network and system infrastructure and protocols.

Still another benefit of the present invention is to make document exchange more secure and hacking proof without adding a lot of data processing overhead and without overburdening existing network and system infrastructure and protocols

The invention also relates to efficiency and ease of use by reduction of message clutter. The user is able to define message containers for every sender or group of senders. If the user does not specify a specific data container per user or group, the software organizes messages per sender. Each subsequent message belonging to identified users or groups is then placed in a designated container rather than the general message bin. However the general message bin retains the link to those messages so that the user is able to change sorting specifications. Various sorting combinations are possible, such as all messages, all new messages, all subscribing and all unsubscribing, as well as other permutations.

### BRIEF DESCRIPTION OF THE DRAWINGS

Various figures are described below.

FIGS. 1-5 describe the preferred embodiment, with alternative embodiment also frequently included.

FIGS. 6 and 7 describe how the present invention applies to social media and data transfer.

FIGS. 8A-8G are a series of screen shots representing one of the simpler embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

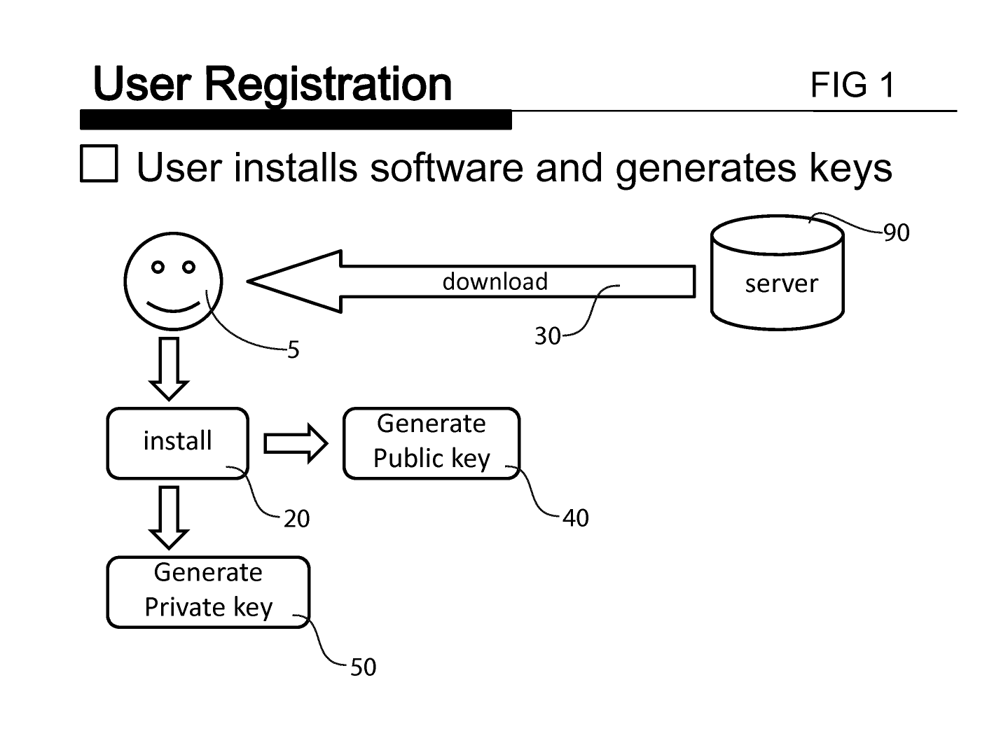

Turning now descriptively to the drawings, in which similar reference characters denote similar elements throughout the several views. All references to the application refers to the apparatus embodied by the present invention. FIG. 1 illustrates the first step in a subscription. A user 5 logs into a server 90 which may function as a central software repository to download the software. Alternatively the central software repository may just be a download facility separate from the server 90. Additionally, the server 90 may be a server process on the user device, which may also be known as first or second device. The software that requires installation is the encryption module 20. Upon installation of the software the client machine, otherwise known as the user device, or a user account, if more than one user 5 is hosted on a user device, is ready to be registered with the server 90. Some personal information may or may not be required during registration, aside from electronic address data. The server 90 then assigns an account with the application. The server is an accepted term in the art, but need not be an actual server, but another client application, which may be disposed on a single server or multiple servers. For example, a company may have several instances of such servers. The sophistication of each instance may depend on grade level of the employee or the stealth level of the message data being sent. The server embodied in this invention is required for registration purposes and need not actually be a central login location as accepted in the art by custom and function.

During the download phase described in FIG. 1, the user downloads the encryption module 20 to a personal user device or a client computer (both shown in later FIGS.), which may be but is not limited to a mobile telephone, organizer, web book, a personal computer, or a network cloud drive. Upon downloading and installing the software, the user 5 is able to utilize the encryption module 20 that has been just been installed to generate a public key 40 and a private key 50 and proceeds with registration on the server 90. The encryption module 20 may prompt the user 5 to enter a password that actually causes the application 20 to generate both the private and the public keys 40 and 50 respectively, as well as the pin code 75 (later FIGS.). Alternatively, any one of the public or private key or a pin code may be generated randomly or pursuant to a password. The password, or a random key code, may then be stored locally or with a third party custodian of authentication data, such as a keychain server 110. If the password is ever corrupted or lost, decryption will fail because the application will no longer be able to decipher the private key and therefore will no longer be able to unencrypt the pin.

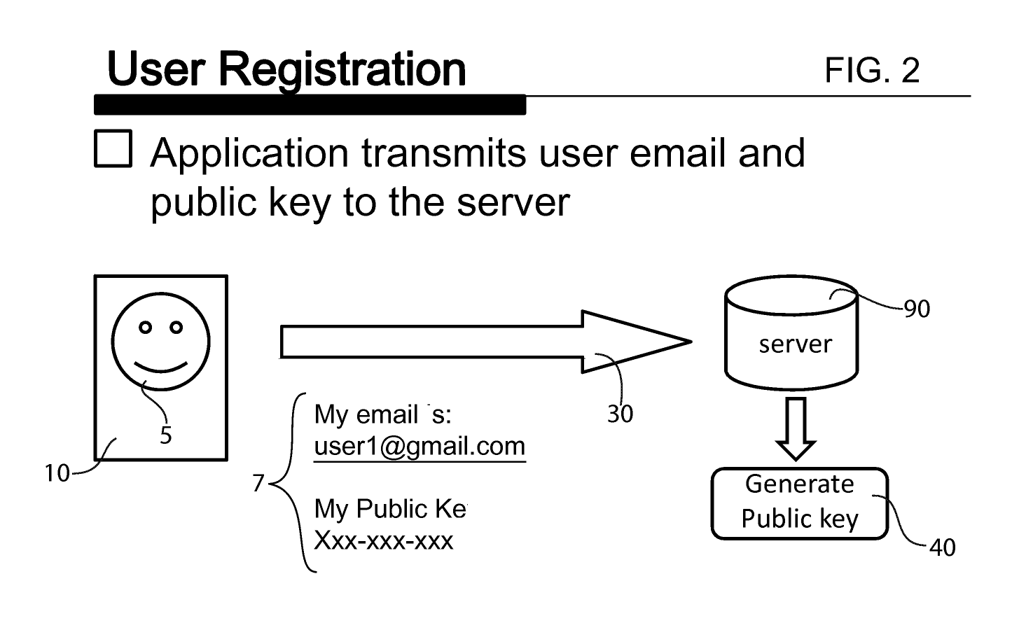

In FIG. 2, the public key 40 is uploaded by encryption module 20 (not shown) to a central location 90, such as a server, with the private key remaining local to location where data or messages will be send from or received. For the purposes of the present invention, data or messages refers to a plurality of data segments representing a text message (sms) or a voice mail message, an email message, a document file, a database file, a video/audio file or any combination thereof. While, this need not necessarily be on the same storage drive, it needs to be readily available to the application 20. Also uploaded to a central location such as the server, are electronic address coordinates 7 of the user or the user process 5, if such have not yet been provided earlier upon installation of the encryption module 20. From this point on, any communication to this user will be associated with the registered address 7 and associated public key 40. The user 5 may change any of these at any time, or it can be set to periodically change or aged out. A change to a public key 40 on the server 90 will require synchronization with the private key 40, which would now reside on the user's client device 10. The public key 40 uploads to the server 90 may be to a server or deamon process on user device 10 or may be on a remote server 90 reachable over the public data carrying medium 30, simpler known as the network. If the user 5 wishes to change his public key 40 on device 10, the software will sync new public key 40 to the server 90. The user is not tied to any single device, and may maintain as many devices 10 as needed. Each device will require a client component 20, which among other things, will ensure that the private 50 and public keys 40 are in harmony.

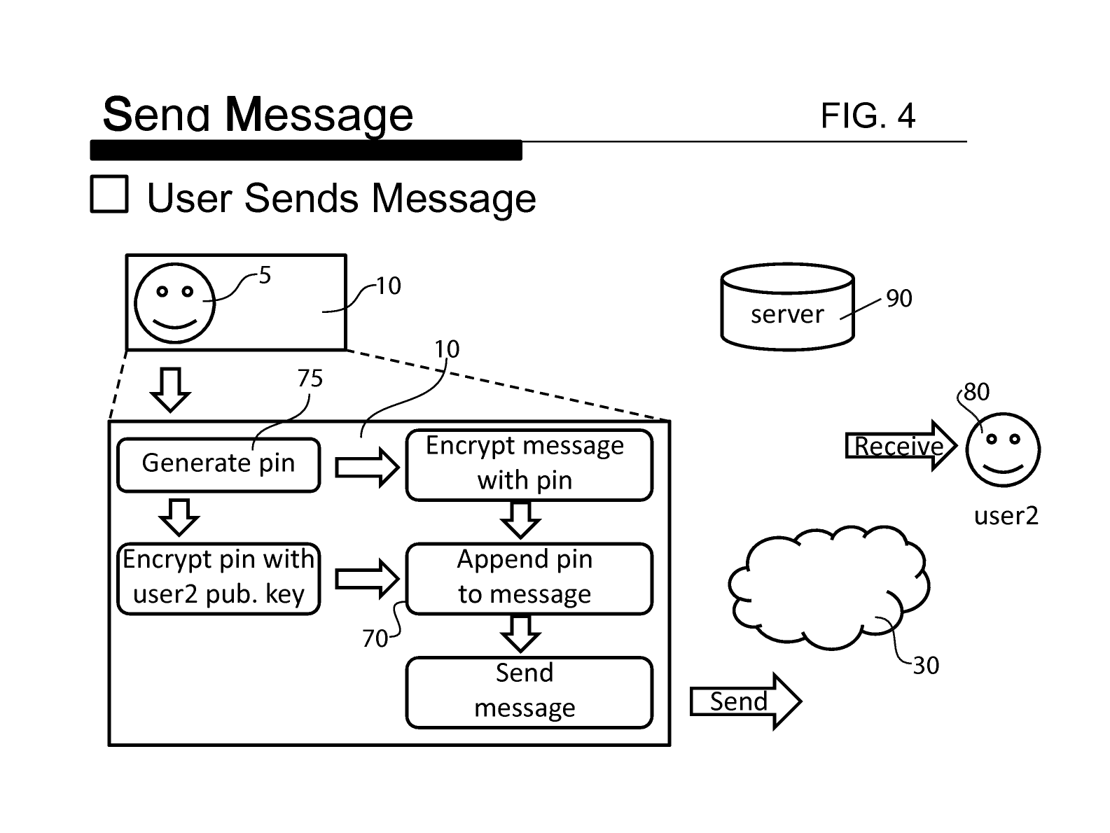

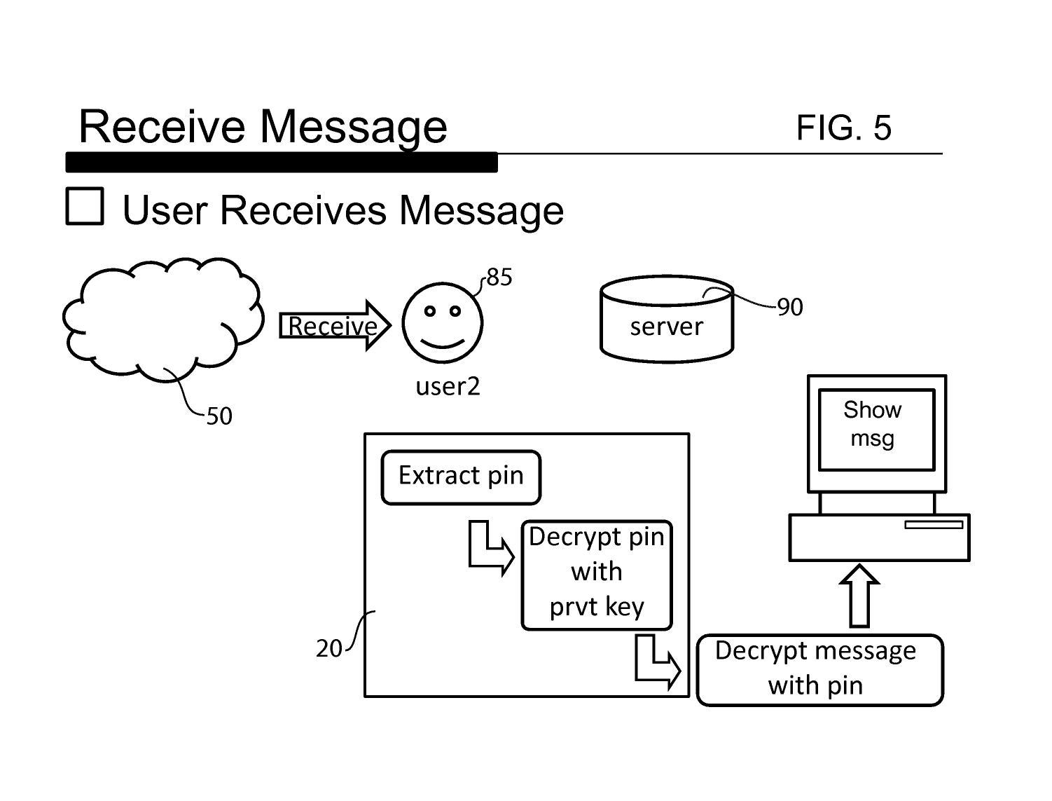

FIGS. 4 and 5 break down the encryption and decryption technique embodied in this invention. During the key generation phase, the user 5 will referably need to enter a password. The password is used to encrypt private key 50 which is stored on user's device 10. The encryption phase of outgoing message uses the following sequence:
1. User device 10 obtains public key 40 of the recipient 80 (otherwise known as the second user or at least one other user) from the server 90;
2. User device 10 generates a random pin 75, and encrypts the message, file or a data segment (70) by using this pin code 75;
3. User device 10 encrypts the pin or pin code 75 by using the public key 40 of the recipient 80;
4. User device 10 appends the encrypted pin 75 to the beginning of the message 75, for example, the first 276 bytes.
5. User device 10 sends the message.

The following sequence of events applies when the recipient receives the message as shown in FIG. 5:
1. Recipient's device 80 received the encrypted message 70
2. Recipient's device 80 extracts the appended encrypted pin 75 from the message header (not shown).
3. Recipient's device decrypts the pin 75 by using recipients private 50 and public key 40 combination
4. Recipient's device decrypts the message by using decrypted pin 75.

The sequence of message encryption and decrypting is only the preferred embodiment but any data segment may be similarly encrypted and decrypted. The registered users can be registered client processes that send data without any kind of human intervention.

The registration embodied in the present invention may be as easy as sending the initial message. The application 20 then uploads the public key 40 back to the account or a unique identifier 120 associated with this user or user process 5, which may be located at the server 90. The public key 40 is then paired up with the user's electronic address information 7. The upload need not be to the same server as the download server and the user may be a person or a user process from a client installation of the application. This private key 50 is linked to the public key 40 and the two are kept in harmony by the application 20. Note, that it is preferred that all active steps, such as synchronizing encryption keys and discovering public keys for other users, are done by the application on the user's device 10. The server component 90 is preferably a passive process. This limits connections between the server and the application on the client's device and reduces the likelihood that a spy process identifies the physical location of the client's device 10. Alternatively, some of the active functions may be transferred to the server application, or reside exclusively on the server level, for example, where multiple servers are coordinating client connection based on load or other factors, such as level of required encryption or failover capabilities.

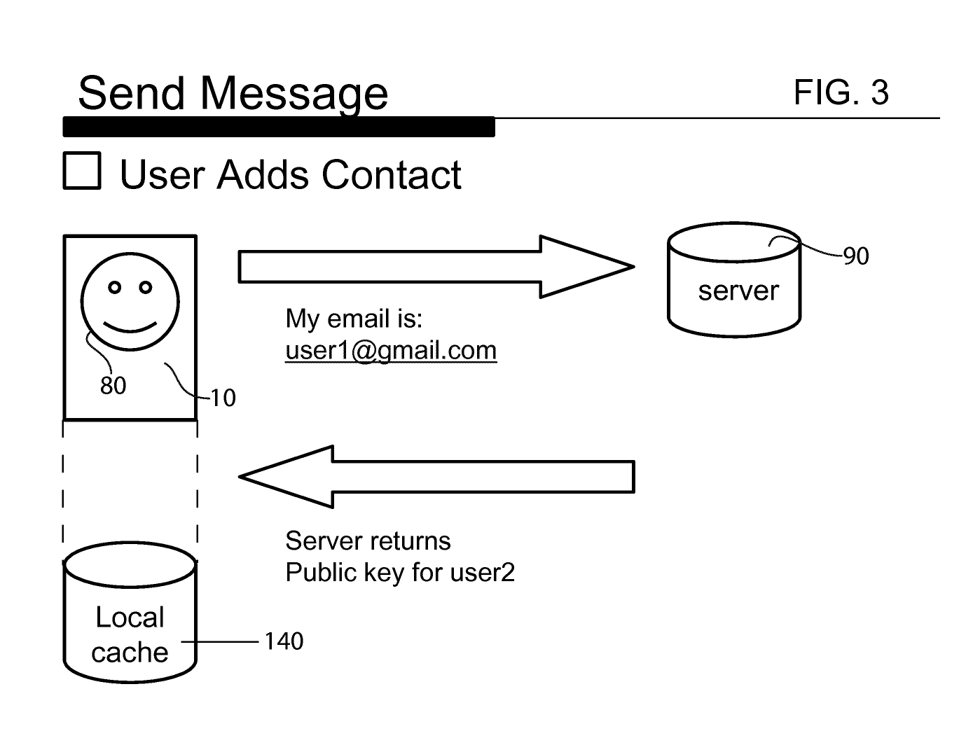

The user1 or first user 5 or the first device or process 10 that is sending data need not continuously query the central location that contains public keys, but may store in a local or private cache 140 those public keys 40 obtained from the most recent message or data disseminations as illustrated in FIG. 3. Having both the public and the private keys be present together on a client machine is not a security weakness, because the public key 40 is only used for encryption and the private key 50 is only used for decryption. Furthermore the keys are only valid in the presence of a valid password or key code pin, which must reside either locally or with a third party custodian.

In scenario shown in FIG. 4 both users are subscribers to the application. The application on user1's 5 device used the automatic discovery mechanism to search the primary key 40, embodied in the present invention, to determine that user2 80 is a subscriber by querying the server, or a third party secure storage facility, to identify whether any public keys are assigned to user2 80. If a public key 40 is discovered after interrogation by the encryption module 20, it is downloaded by user1 application 20 on the first device 10 and stored in local cache 140 for later reference. Note that the discovery process of the application 20 would maintain harmony with the local cached public key 40 and server based public key 40, to guard against user2 80 regenerating his or her public key before user1 has had the chance to dispatch a message to user2. Alternatively, user2 may be able to specify whether his or her public key 40 should be stateful (meaning whether or not it should time out, or become stale after passage of time with respect to the cache of other users. For the purposes of this invention user1 and user2 or first and second user are completely interchangeable in terms of functioning as a sender and receiver of messages 70.

In FIG. 4, user1 5 composed a message 70, or otherwise assembled data to be sent to user2 80. The application 20 generates a random pin 75 and encrypts the message 70 by using that random pin. The application encrypts the pin by using recipient's public key and appends the key to the message. The public key 40 is obtained by the application 20 from the server 90 or from its local cache 140. This discovery mechanism is automatic. In other words, the application uses its build-in intelligence to determine whether its cache 140 contains the required public key 40. If the public key is not present in the cache, it will reach out the server. It may also have the capability to ensure that the public key 50 is in sync with the same public key on the server 90. The most elementary way to do this is to age the public key and discard it after it has resided in the cache for some brief period of time. This feature is also desirable, since the fewer public keys a single client device contains, the more robust is the entire network. For example, if a given computer is known to be sending many dozens of emails to different users. A hacker who compromised one of the machines on the address list, need only compromise just another machine, this high volume computer, in order to obtain both the private and public keys. Thus security is improved if the public key is intentionally invalidated by the local application and not permitted to linger for extended periods of time. In another alternative, the local cache may be made readable only to the local application processes, and any access to it from an alternative source would automatically delete the cache. In FIG. 5 as shown, the application has used its local cache and the serve need not participate in the communication.

The application need not use any unique data transfer protocol. Once the data has been encrypted by the application processes, it can move about the network using existing protocols. In the illustration, the protocol used is SMTP, which is generally used for electronic mail. However, one skilled in the art would appreciate that file transfer protocols such as, but not limited to FTPS and SFTP may also be used in conjunction with the present invention.

Once user2 80 has received the message, the application on the device belonging to user2 is able to decrypt the message with its local private key. No access to the server is required to decrypt the message. If the private key is missing or corrupt, or if an incorrect public was used to encrypt the message, user2 80 will not be able to read these messages. On the other hand, if the correct private and public key relationship had been preserved, the messages on user2's device can be used as any other unencrypted message, file or a segment of data.

The server used in the present invention is utilized primarily for discovery of public keys. It need not store any personal client information. The public keys are linked to user's email address or another identifying unique piece of data. Any personal information provided by a user during registration with the application may be stored on a server that is used just for registrations. Once the registration is completed and the application is installed on the user's device, the application may automatically seek to connect to the public key server, or to a group of servers, register the device and receive a private key.

In the present invention, the actual piece of data is encrypted synchronously using a randomly generated number which is generated by the application. The public key is then used to encrypt the randomly generated number. On the device belonging to user2, the application decrypts the password with a private key and then uses the same random number to decrypt the rest of the file. Thus, in order to break the encryption, the device belonging to user2 and which contains the private key must either be ceased or compromised, but even after doing so the interceptor must also possess the original password do decrypt the private key, which can then be used to decrypt the message.

The secure data transfer concept described in the present invention, can be used for single or multiple data entity transfer. For example, in case of SMPT messaging, a user sending a message to thirty other users may do using the same application processes as when sending to just one user. In the background, the application discovers and fetches a public key for each user in the list of recipients or determines whether a particular user is not a subscriber. A variety of data types may be similarly encrypted for each of the users or target devices in the list. Then the message, or a segment of data, is sent out to the network using any of the existing message transfer and network transfer protocols. In the event where one or more users or target devices is found to be non-subscribing, the application may prompt the sender to confirm the transfer and acknowledge that at least one user will be receiving messages insecurely. All messages, however, may be sent as either encrypted or unencrypted in accordance with sender's discretion. The user can affirm his or her choice by selecting the appropriate action for every message. Alternatively, the user may preconfigure which users, or messages, or data type or content should be encrypted and which can be sent outright.

The messages and other data received by the application are preferably always stored in their encrypted state. When a user wishes to select a particular message, the application unencrypts the message with the local private key before making it accessible to the user. A user may opt to open several messages or files at the same time, and keep opening additional messages or files for as long as the local system resource limits permit this. However, once a message or a file is closed, the encryption is reinstated. For this reason, if a user's private/public key combination changes, the application will seek and update all locally stored encrypted messages and files

If a user wishes to reply to a message to all of the original senders, incorporating the users who generated the message and those who were included as parties to the message or additional recipients of the message, the application permits the user to include any attachments with the reply to none, some or all users on the address list. To accomplish the attachment forwarding, a user need not be limited by the forward feature that is available with most messaging applications, since the forward feature of these applications also discards the list of the original users from the list of addressees. Instead the user may utilize reply to all or some with the original attachment, thus preserving the address list.

To increase security and decrease clutter, the present invention groups messages or data by sender, a group of senders, by topic or content. The grouping occurs automatically, or may be additionally configured or disabled by the user of the application.

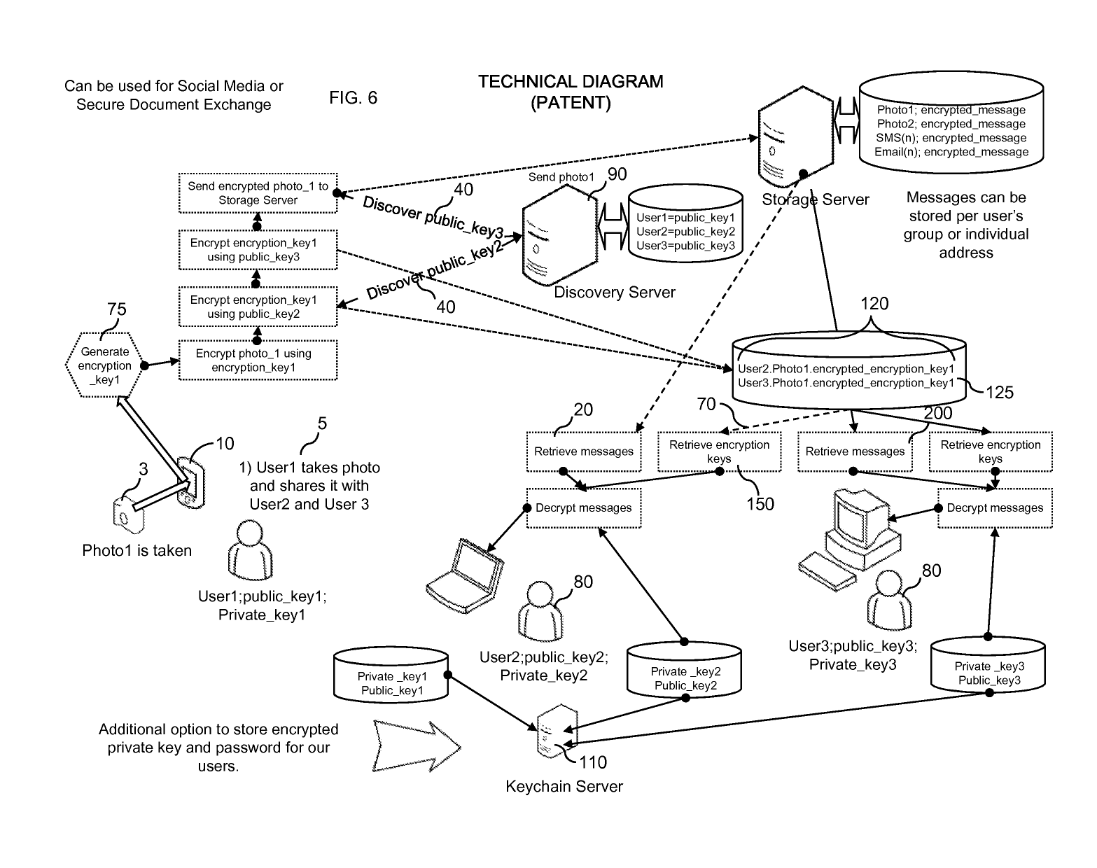

Turning now to FIG. 6, disclosed is an illustration of how the inventive concept embodied in the present invention is integrated in a standard social media settings. As typically happens, user1 snaps of a photo1 3 on his private device 10. Now user 5 wants to share it with his friends, user2 80 and user3 80. First, as soon as user1 attempts to upload his or her image to the social page, a background process generates a random encryption key1, otherwise known as pin code 75 and encrypts the photo. Once completed the same or different background server of the encryption module 20 accesses the discovery server 90, which previously referred to as just the server 90, and obtains public keys 40 for users 2 and 3 and encrypts the encryption key1 with these public keys. If either user's public key 50 is not found, user 1 is notified and an email may be sent to the user whose key is missing to create or repair his or her account on the discovery server. Once the encryption key 1 75 is encrypted, the local background process within the encryption module 20 sends the encrypted messages and a unique message identifier 120 to a storage server process 130 that stores encrypted SMS, data and email messages but not public keys. The storage server process 130 may be a process on any of the user devices 10, or be located on a remote server. The local background process also sends the message identifier 120 and public key 40 to the discovery server, and notifies a mapping server 125, which may be a separate server, or a server process on the discovery server 90 that a new message having the unique message id is pending for user2 and 3, it in turn notifies users 2 and 3 of the message. Users 2 and 3 will then request the mapping server 200, to retrieve the data stored on the storage server and the encryption key 1 75 from the discovery server, which the mapping server accomplishes by linking the messages using the unique messages identifier or id. In another embodiment the user's local process is capable of linking the two pieces of communication based on unique message identifier that it receives directly from the discovery server. The message is the decrypted by decrypting the encryption key 1 with the user's private key and decrypting the message using the decrypted encryption key1.

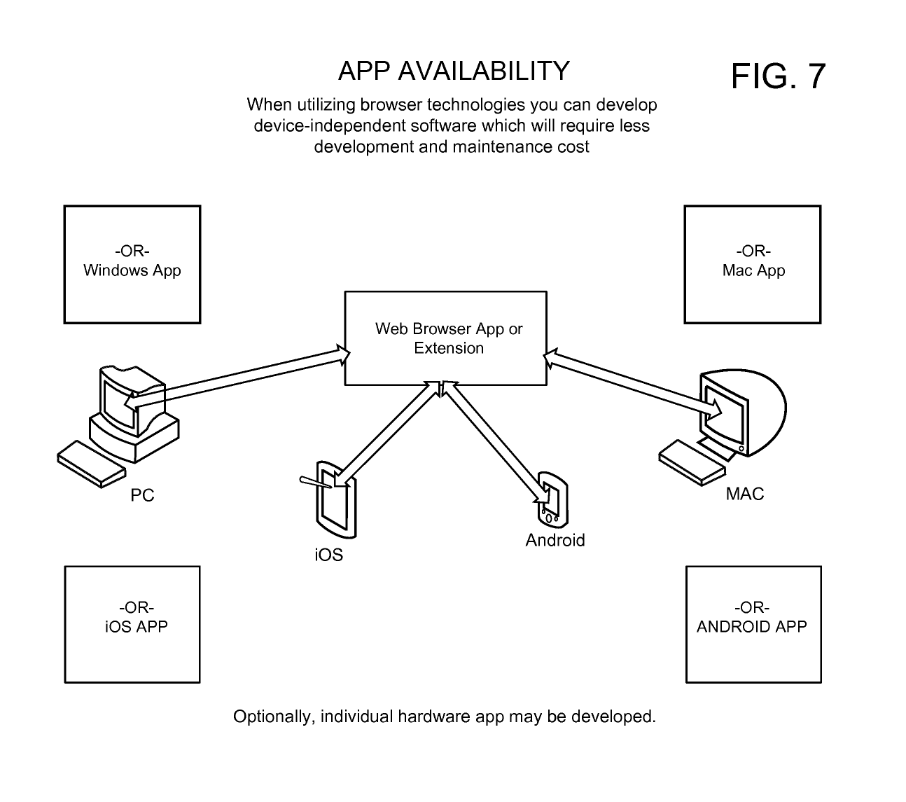

As a further improvement to the present invention, the public 40 and private key 50 combination for each user may be stored on a separate keychain server 110. The encryption module 20 will then be requesting a private key from the keychain server 110 and a public key from the discover sever. The discovery server 90 will then only have the identifier linked to the public key to request the public key from the keychain server. The keychain server itself, can only interact with the discover server and each user's private background process. To decrypt messages a user will use a different unique identifier to request a private key from the keychain server in order to decrypt messages. The purpose of the keychain server is to further make a concerted and determined hacking more difficult and time consuming. The data or document exchange would occur the same way, except that photo1 would now be replaced by file 1. The private background process may be a background application specifically compiled for Windows, Unix/Linux, iOS and Android platforms or may be a platform neutral advance browser plugin as indicated in FIG. 7.

FIG. 6 also illustrates that the present invention enables the functionality of a payment collection server 150. The payment collection server 150, like other servers of this invention, may be a standalone server or a process running on a mapping server 125 or the discovery server 90. The payment collection is require when user2 80, or any other user the secured community of users whose privacy of communications the present invention aims to protect, is presented with an encrypted plurality of data segments 70 representing a paid service, file, image or subscription. For example the particular data segment is a photo, a movie clip (or an entire movie) or a music file. However, in this case, if user2 80 upon notification of such message, attempts to download it, he or she is prompted by the collection server 150 to submit payment. User2 would not be able to view the file without paying, because for example, the pin code 75 would be missing from the message. Upon user2's submission of payment, encryption software on the first device 10 of user1 5 (or any user who originated this type of message) is notified of payment, prompting the encryption software to forward to user2 80 a valid pin code 75.

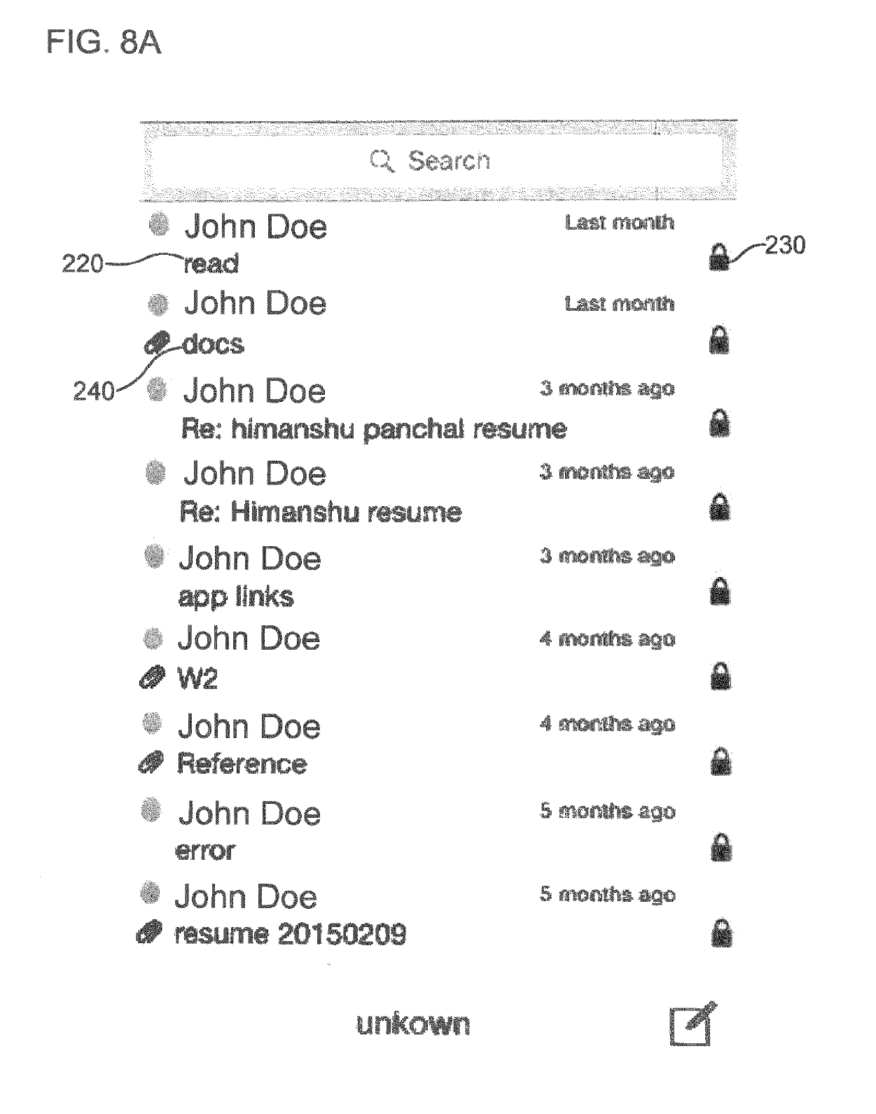

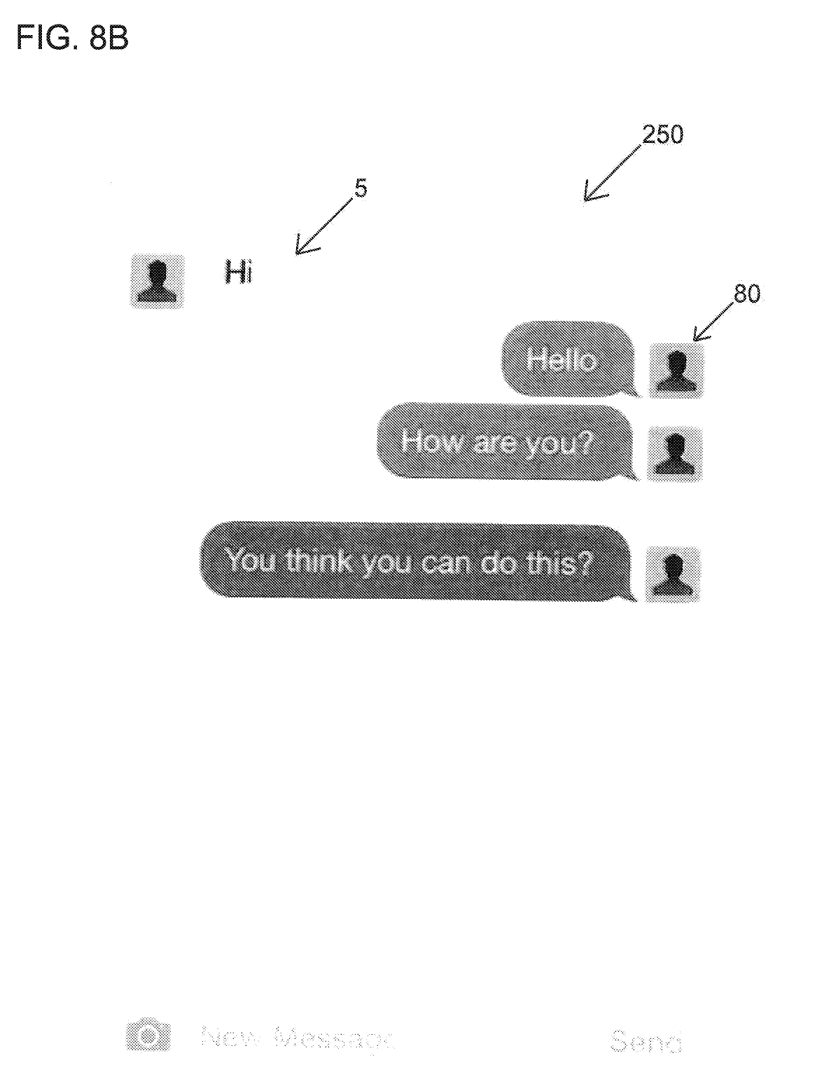

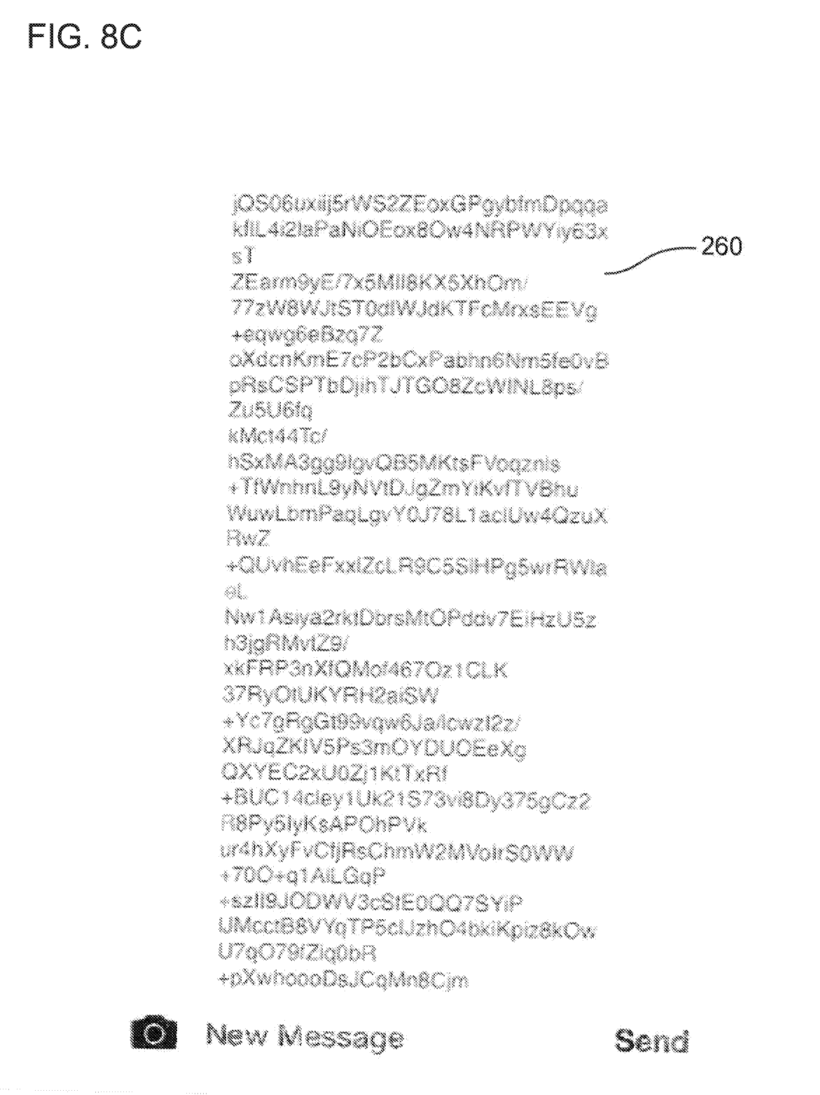

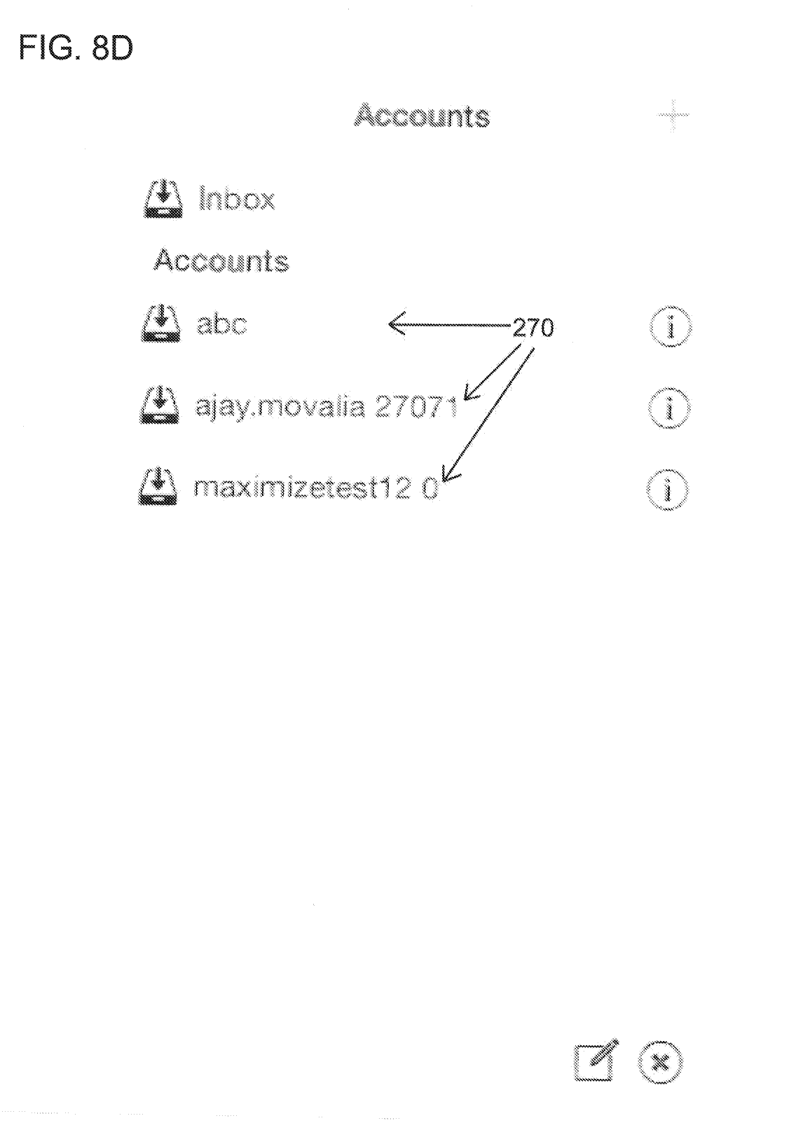

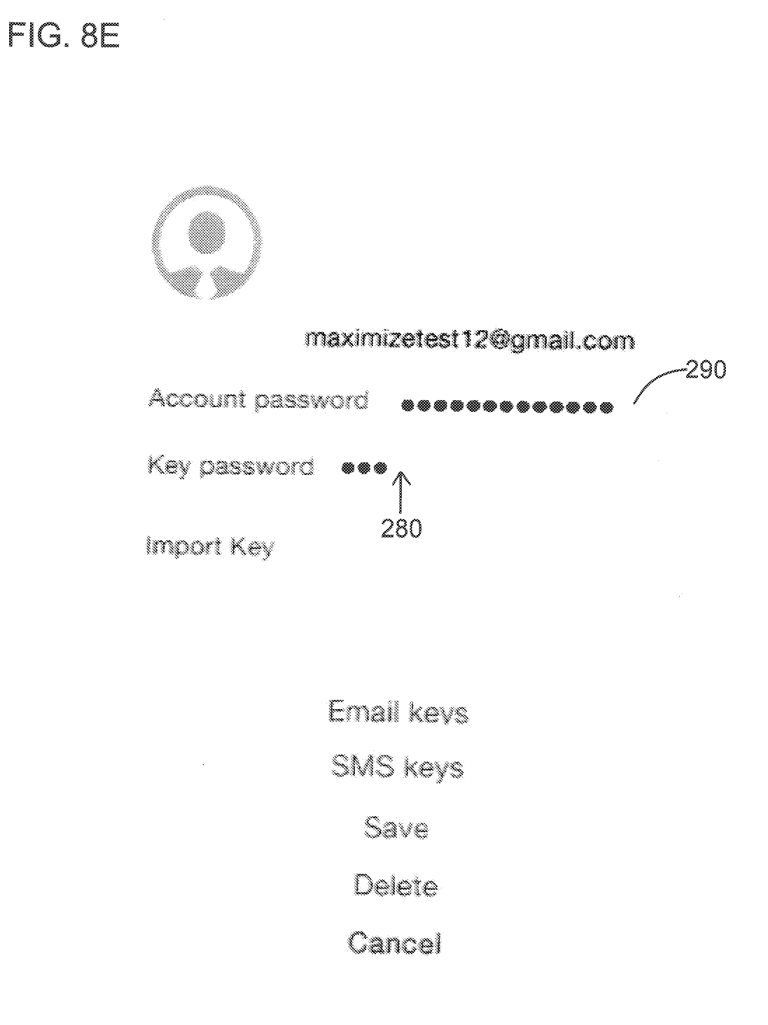

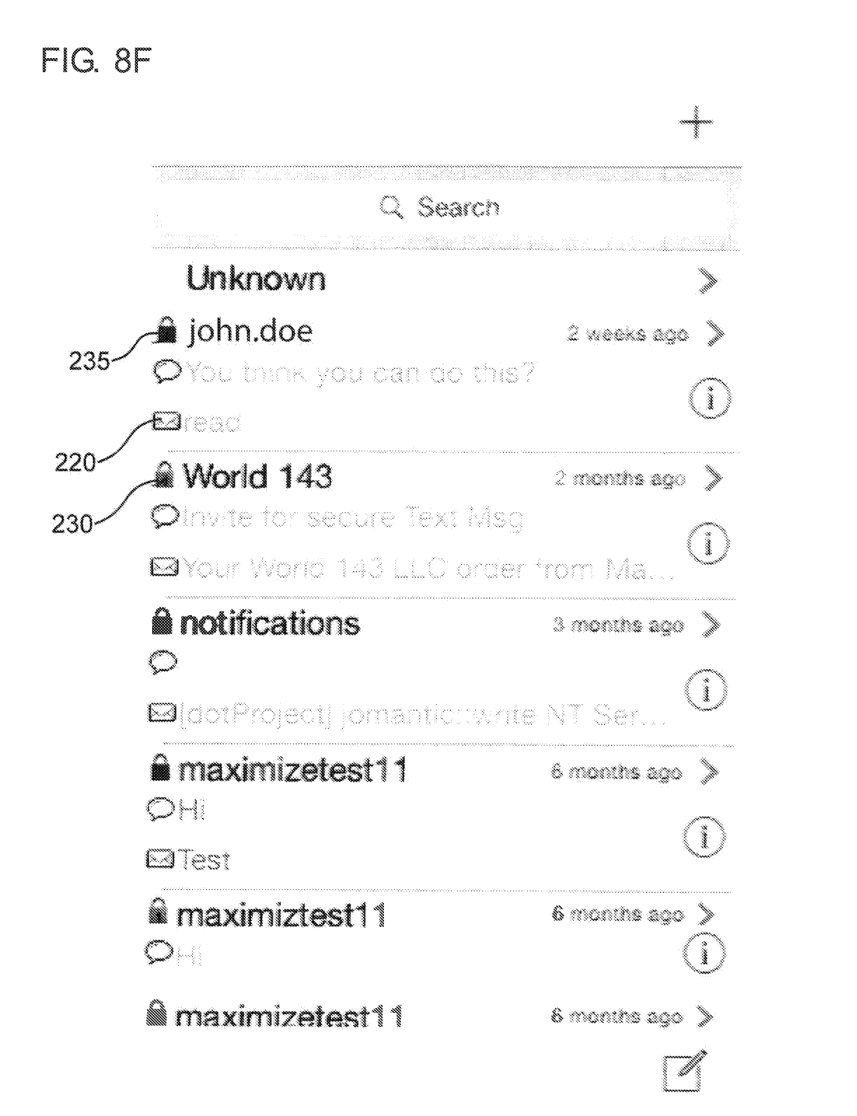

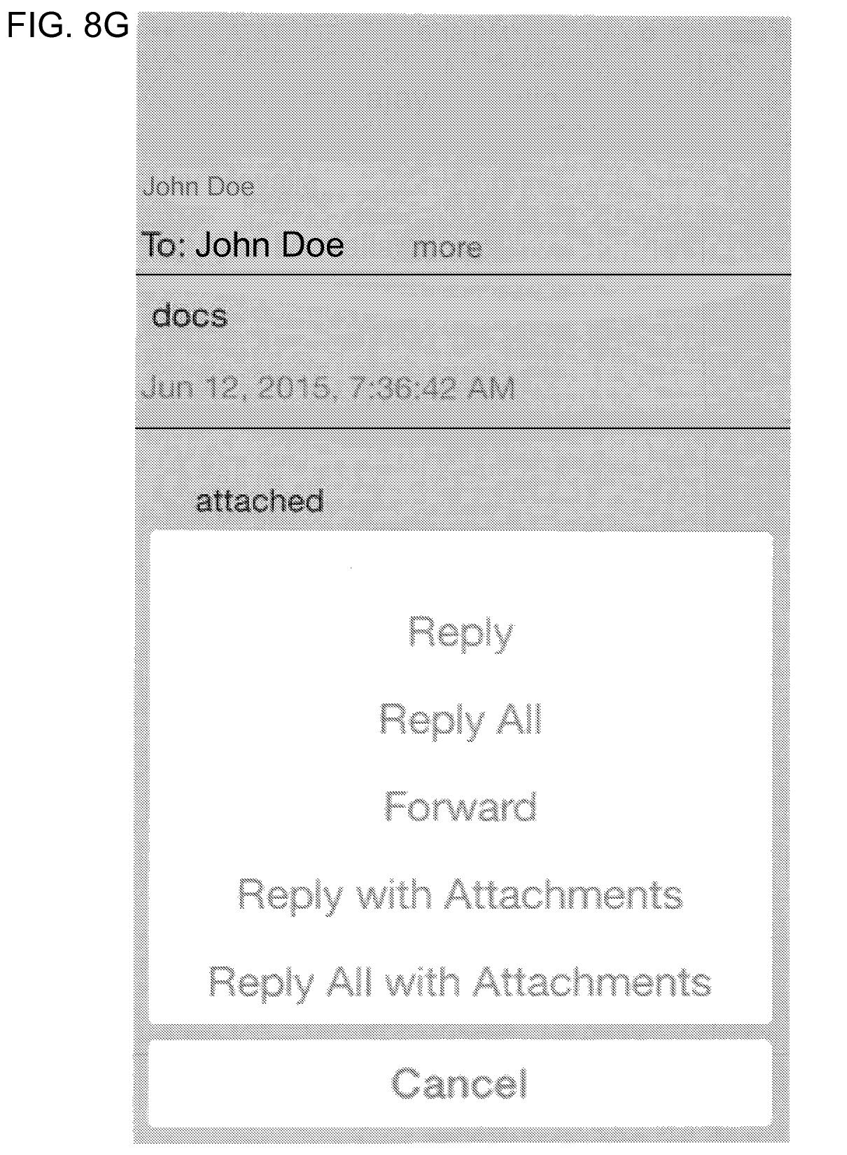

FIG. 8A is a screen shot of an email interface showing the plurality of data segments represented by the email message 220, which may have an attachment 230. As shown in FIG. 8B, the data segments here are SMS (text messaging). The messages in the screen 250 are unencrypted. The screen belongs to first user 5. Therefore messages from second user 80 were decrypted using second user's public key 50. The messages from first user 5 are decrypted by second user 80 on second user's device using first user's public key. If the public key is not found, or if a user does not have access to a private key views the message it appears as gibberish 260. The encryption module 270 works with several user accounts 270 on the same physical machine.

FIG. 8e. demonstrates how a pin code 75 is set. It may be generated randomly or using a key password 280. The account 290 is used to login to the user's native email system, such as yahoo or gmail. First or second user 5 or 80 respectively, may receive and reply to messages easily preserving attachments.

FIG. 8f. shows that in some cases users are not part of the secure community of users and their messages are sent and received without encryption. These messages are shown with green symbol 235, alerting the first user of their unsecured status.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A electronic secure data exchange comprising: a first user having a first device, said device having an encryption module; wherein said encryption module listening for data outbound and data inbound; wherein said inbound and said outbound data arrives and is dispatched from said first user device by means of a connection to a public data carrying medium; said encryption module generating a public key and a private key; said encryption module generating pin code; wherein said encryption module encrypting a plurality of data segments using said pin code; a second user having a second user device having said encryption module, said encryption module generating said public key and said private key for said second user; said encryption module randomly generating said pin code wherein said pin code on said second user device used to encrypt said plurality of data segments produced by said second user; wherein said encryption module on said first device encrypting said pin code for said plurality of data segments for said first user with said public key of said second user; wherein said public key being requested by encryption module on said first device from encryption module on said second device; and wherein said plurality of said data segments in combination with said pin being received by said second device after being sent by said first device; and wherein said encryption module decrypting said pin received from said first user and using said pin from said first user to decrypt said plurality of data segments.

2. The electronic secure data exchange of claim 1, wherein said public data carrying medium is from a group comprising wired local area network or wireless local area network; wherein said plurality of data segments is from a group comprising short message service or a data unit managed by a transfer control protocol or user datagram protocol.

3. The electronic secure data exchange of claim 1, further comprising a central server, wherein said first user or said second user downloading said encryption module to said first device or said second device.

4. The secure data exchange of claim 1, further comprising a central server, wherein said encryption module of said first device and said second device upload said public key for said first user and said second user to said central server and wherein said encryption module of said first device interrogating said central server to obtain said public key of said second user.

5. The secure data exchange of claim 4, wherein said encryption module of said second device interrogating said central server to obtain said public key of said first user, said encryption module using said public key to encrypt sand randomly generated pin number for said second user, said randomly generated pin number of said second user encrypting said plurality of data segments on said second device.

6. The secure data exchange of claim 1, wherein said first user or said second user sending said plurality of data segments to each other, wherein said first user interrogating said encryption module on said second device to obtain said public key of said second user, and wherein said encryption module on said second device interrogating said first device for said public key of said first user.

7. The secure data exchange of claim 1, further comprising non-encrypted mode, wherein said encryption module sending said plurality of data segments after failing to find said public key for said second user, or wherein said encryption module for said second user failing to locate said public key for said first user; and wherein said encryption module having a user interface giving said first or said second user the ability to select encrypted or non-encrypted messages.

8. The secure data exchange of claim 1, wherein said plurality of data segments represent a group comprising text messages, email messages, documents, application data, and media files.

9. The secure data exchange of claim 8, wherein said plurality of data segments may be broken up by said encryption module into smaller segments on said first device, and wherein said smaller segments may be reassembled again by said encryption module on said second device.

10. The secure data exchange of claim 1, further comprising a keychain server, wherein said keychain server holding said private key.

11. The secure data exchange of claim 1, wherein said plurality of data segments are stored in encrypted state on said first device or said second device, and wherein said encryption module decrypting said plurality of data segments upon detecting a read or a view action by said first or said second user against said plurality of data segments.

12. The secure data exchange of claim 1, wherein said encryption module listening for data inbound and data outbound messages from said first user or said second user, wherein said second user or said first user utilizing conventional software packaging.

13. A secure data exchange community comprising: a first user from a community of users all having data processing devices, said user being on a first device, said device having an encryption module; wherein said encryption module being triggered by said first user's action to send data outbound or receive data inbound, said data outbound and said data inbound comprising a plurality of data segments; wherein said data inbound and said data outbound messages are sent and received by said first device by means of a connection to a public data carrying medium between said first device and a plurality of devices from said community of users; said encryption module generating a public key and a private key and a pin code; wherein said public key being stored on a central server process; said encryption module utilizing said pin code wherein said encryption module encrypting a plurality of data segments using said pin code; wherein said encryption module encrypting said pin code with said public key for at least one other user from said community of users, said public key being obtained from said central server process; wherein said encryption module sending a combination of a unique message identifier generated by said encryption module and contact information of said one other user to a mapping server; wherein said mapping server sending a notification to said at least at least one other user of a message received from said first user; said one other user accessing said mapping server to retrieve said unique message identifier and using said unique message identifier to retrieve said plurality of data segments from a storage location; and said encryption module on said device of said one other user utilizing said private key to decrypt said message comprised of said plurality of data segments.

14. The secure data exchange community of claim 13, wherein said storage location is a storage server process, said storage server process storing a combination of encrypted plurality of data segments linked to a unique message identifier.

15. The secure data exchange community of claim 13, further comprising a keychain server, wherein said encryption module storing said private key on said keychain server.

16. The secure data exchange community of claim 14, wherein said plurality of data segments represent a group of data types comprised of electronic email, SMS messages, documents, video files, audio files, computer application readable data.

17. The secure data exchange community of claim 13, wherein said plurality of data segments are stored in encrypted state; wherein said encryption module decrypts said plurality of data segments upon detection a read or view action against said plurality of data segments.

18. The secure data exchange community of claim 13, wherein said encryption module further comprises a cache location wherein said plurality of data types are stored in said cache location.

19. The secure data exchange community of claim 13, further comprising a payment collection process in exchange for said plurality of data segments; wherein said encryption module withholding said pin code until said other user pays a fee through said collection process; wherein the said other user retrieves said plurality of data segments from said storage location and able to decrypt said pin code using said private key after sending said first user a plurality of data segments, wherein said plurality of data segments comprises payment information.
